(19) United States
(12) Patent Application Publication
(10) Pub. No.: US 2023/0327423 A1
(43) Pub. Date: Oct. 12, 2023

(54) CONNECTION MECHANISM OF TRANSMISSION LINES

(71) Applicant: Edom Technology Co., Ltd, Taipei City (TW)

(72) Inventor: HSIANG-JEN WANG, Taipei City (TW)

(21) Appl. No.: 17/964,612

(22) Filed: Oct. 12, 2022

Related U.S. Application Data
(60) Provisional application No. 63/329,548, filed on Apr. 11, 2022.

(51) Int. Cl. H02G 15/18

(52) U.S. Cl. CPC H02G 15/18

(57) ABSTRACT

This disclosure is a connection mechanism of transmission lines, which comprises two transmission lines, a circuit board, a chip, a metal shell and an insulation shell. The outer sheath at one end of the two transmission lines is removed, and then conducting wires and conductive layers will be exposed. The conducting wires of the two signal transmission lines are connected to each other through the circuit board and the chip, and the metal shell covers the circuit board and the chip. Further, the metal shell is connected to the exposed conductive layer of the two transmission lines, and the insulation shell covers the metal shell and part of the two transmission lines. The connection mechanism is formed between the two transmission lines to extend the length of the transmission line, which improves the connection strength and compensates the attenuation of the transmission signal.

### REFERENCE TO RELATED APPLICATIONS

This non-provisional application claims priority under 35 U.S.C. § 119(a) on U.S. Provisional Application No. 63329548 filed Apr. 11, 2022, the entire contents of which are incorporated herein by reference.

### BACKGROUND

### Technical Field

This disclosure is a connection mechanism of transmission lines, which can extend the length of the transmission line without disposing female and male connectors on the transmission lines. Further, it can compensate the attenuation and distortion of the transmission signal, and can improve the interference caused by the plug-in connector and the signal attenuation caused by the poor waterproofness.

### Related Art

Transmission lines can be used to transmit high-frequency signals. During the transmission process of high-frequency signals, the transmission line radiates an electromagnetic field, resulting in energy loss of high-frequency signals. Therefore, the transmission line is usually provided with a shielding layer to prevent the energy loss of high-frequency signals and the interference of any existing electromagnetic field around it.

Generally, the length of the transmission line has its limitations. If the overall length of the signal transmission line is longer, the voltage drop caused by the copper conductor and power attenuation of the transmission signal will be greater. When the power attenuation exceeds a certain range, it will cause loss, error or distortion of the transmission signal. For example, the length of the USB transmission line is mostly within 3 meters, and 1.2 meters is better. If the frequency of the transmission signal is higher, the length of the transmission line may be shorter to prevent errors of the transmission signal.

### SUMMARY

This disclosure provides a connection mechanism for transmission lines, which includes at least two transmission lines, a circuit board, at least one chip, a metal shell and an insulation shell. The transmission line includes a plurality of conducting wires, a conductive layer and an outer sheath, wherein the conductive layer covers the conducting wires, and the outer sheath covers the conductive layer.

The outer sheath at one end of the transmission line is removed, and thus the conducting wires and the conductive layer at one end of the transmission line are exposed. The conducting wires of the two transmission lines are electrically connected to each other through the circuit board and the chip, the chip is configured to compensate and reduce the attenuation of the transmission signal, and the circuit board and the chip are covered by a metal shell.

The metal shell is connected to the conductive layers at one end of the two transmission lines, and is configured to shield the circuit board and the chip covered by the metal shell. Further, the insulating shell covers the metal shell and one end of the two transmission lines to form the connection mechanism between the two transmission lines, and the insulating shell is able to prevent the metal shell from directly contacting the external environment. Through the content described in this disclosure, it is not necessary to arrange corresponding male and female connectors on the transmission lines to increase the length of the transmission line, which can not only improve the strength of the connection of the transmission lines, but also can compensate or reduce the attenuation of the transmission signal. On the contrary, the length of the conventional transmission line is extended by male and female connectors, which may cause interference and signal attenuation.

In one embodiment of this disclosure, the exposed conductive layers on the two transmission lines can be folded to the outer sheath to form a folded part on the outer sheath. In addition, a thinned part may be formed on the outer sheath at one end of the transmission line, and then the exposed conductive layer can be folded to the thinned part.

In other embodiments, part of the outer sheath at one end of the two transmission lines may be removed to form a cutting part on the two transmission lines, and the conductive layer on the cutting part is exposed to form an exposed conductive layer at one end of the two transmission lines. By disposing the thinned part and the cutting part, the cross sectional area and volume of the connection mechanism of the transmission lines can be further reduced.

To achieve the object, this disclosure provides a connection mechanism of transmission lines, which comprises at least two transmission lines, a conductive layer, an outer sheath, a circuit board, at least one chip, a metal shell and an insulation shell. The two transmission lines includes a plurality of conducting wires, wherein each conducting wire includes an inner conducting core and an insulation layer, and the insulation layer covers the inner conductor core. The conductive layer covers the plurality of conducting wires, and the outer sheath covers the outer peripheral surface of the conductive layer, wherein the conductive layers at one end of the two transmission lines are exposed to form an exposed conductive layer. The circuit board is located between the two transmission lines and is electrically connected to the conducting wires of the two signal transmission lines, and the chip is disposed on the circuit board. The metal shell covers the circuit board and the chip, wherein the metal shell is connected to the exposed conductive layer of the two signal transmission lines, and the circuit board and the chip are located in an accommodating space formed by the metal shell, and the insulation shell covers the metal shell and part of the two signal transmission lines.

### BRIEF DESCRIPTION OF THE DRAWINGS

This disclosure will become more fully understood from the detailed description given herein below for illustration only, and thus not limitative of this disclosure, wherein:

FIG. 1 is a schematic exploded perspective view of a connection mechanism of transmission lines according to an embodiment of this disclosure.

FIG. 2 is a cross section view of the transmission lien according to an embodiment of this disclosure.

FIG. 3 is a cross section view of the transmission lien according to another embodiment of this disclosure.

FIG. 4 is a schematic three-dimensional of the transmission line according to another embodiment of this disclosure.

FIG. 5 is a cross section view of the transmission lien according to another embodiment of this disclosure.

FIG. 6 is a schematic three-dimensional of the transmission line according to another embodiment of this disclosure.

FIG. 7 is a schematic three-dimensional of the connection mechanism of transmission lines according to an embodiment of this disclosure.

FIG. 8 is a schematic three-dimensional of the connection mechanism of transmission lines according to another embodiment of this disclosure.

FIG. 9 is a schematic three-dimensional of the connection mechanism of transmission lines according to another embodiment of this disclosure.

### DETAILED DESCRIPTION

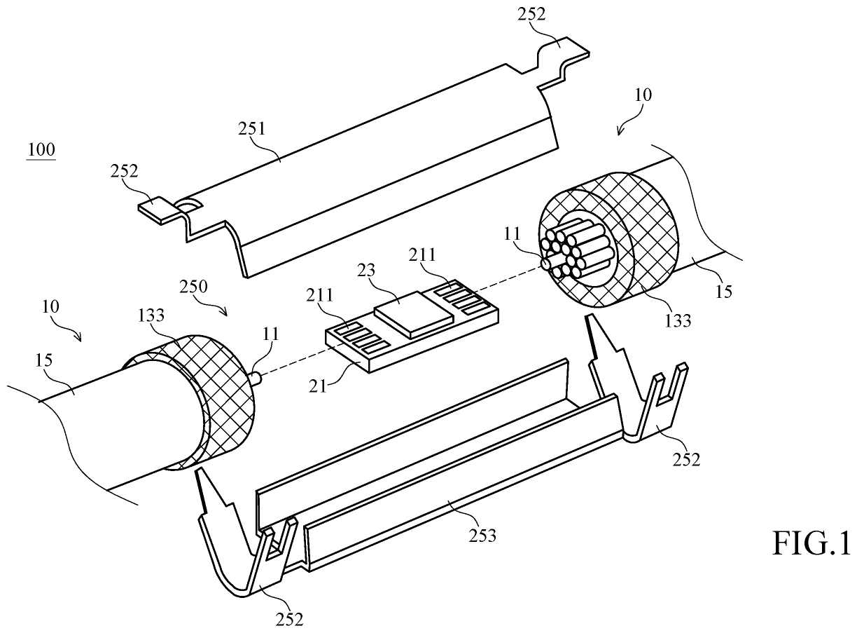

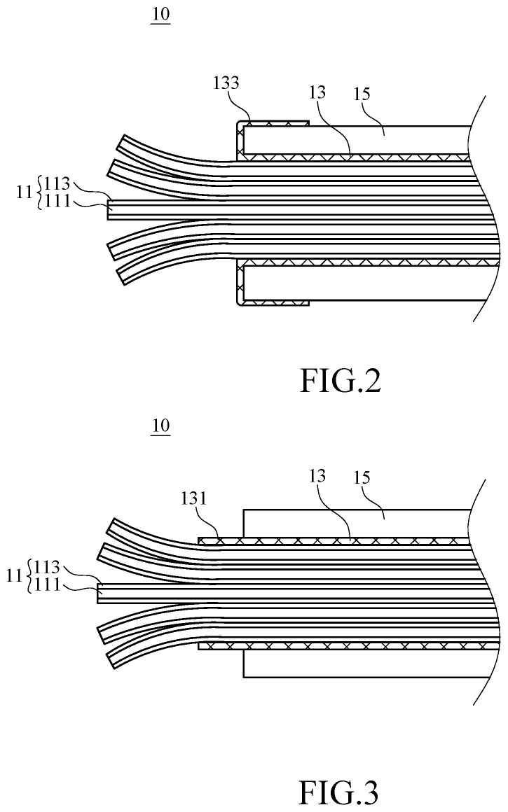

FIG. 1 is a schematic exploded perspective view of a connection mechanism of transmission lines according to an embodiment of this disclosure. FIG. 2 is a cross section view of the transmission line according to an embodiment of this disclosure. The connection mechanism 100 of the transmission lines includes at least two transmission lines 10, a circuit board 21, at least one chip 23 and a metal shell 25, wherein the chip 23 is disposed on the circuit board 21 and is electrically connected to the two transmission lines 10 via the circuit board 21, and the metal shell 25 is configured to cover the circuit board 21, the chip 23 and part of the two transmission lines 10.

In one embodiment of this disclosure, as shown in FIG. 2, the transmission line 10 may include a plurality of conducting wires 11, a conductive layer 13 and an outer sheath (jacket) 15, wherein the conductive layer 13 is configured to cover the plurality of conducting wires 11, and the outer sheath 15 covers the outer peripheral surface of the conductive layer 13.

The conducting wire 11 includes an inner conducting core 111 and an insulation layer 113, wherein the insulation layer 113 covers the outer peripheral surface of the inner conducting core 111 to isolate the inner conducting cores 111 of each conducting wire 11.

The conductive layer 13 may be a single-layer or multi-layer structure. For example, the conductive layer 13 may be formed by either braided or spiral metal wire, or aluminum foil with or without Mylar, and then a metallic mesh to form a grounding shelter around the conducting wires 11 to prevent the signal transmitted by the conducting wires 11 from being interfered by external electromagnetic.

In another embodiment of this disclosure, the conductive layer 13 may be a two-layers or multi-layers structure, and may include a mesh conductor and an Al Mylar, wherein the Al Mylar covers the conducting wires 11, and the mesh conductor covers the Al Mylar.

The outer sheath 15 is made of an insulating material. The outer sheath 17 has functions, such as insulation and waterproofing, and is used to protect and fix a plurality of wires 11. For example, the outer sheath 15 includes polyvinyl chloride (PVC), low density polyethylene (LDPE), fluorinated ethylene propylene copolymer (FEP), or thermoplastic elastomer (TPE). Specifically, the transmission line 10 of the embodiment may be a coaxial cable, an USB transmission line or HDMI transmission line.

As shown in FIG. 3, the outer sheaths 15 at one or both ends of the two transmission lines 10 can be removed, and the conducting wires 11 and the conductive layer 13 at one end of the transmission line 10 are exposed, wherein the conductive layer 13 forms an exposed conductive layer 131 at one end of the transmission line 10. Further, the insulation layers 113 at one end of the conducting wires 11 may be removed, and the inner conducting cores 111 at one end of the conducting wires are exposed.

As shown in FIG. 2, the exposed conductive layer 131 is further folded to the outer sheath 15 to form a folded part 133 on the surface of the outer sheath 15. The exposed conductive layer 131 folded to the outer sheath 15 is only an embodiment of this disclosure. In practical applications, the exposed conductive layer 131 may not be folded to the outer sheath 15, and the two transmission lines 10 shown in FIG. 3 may be connected to each other via the connection mechanism 100.

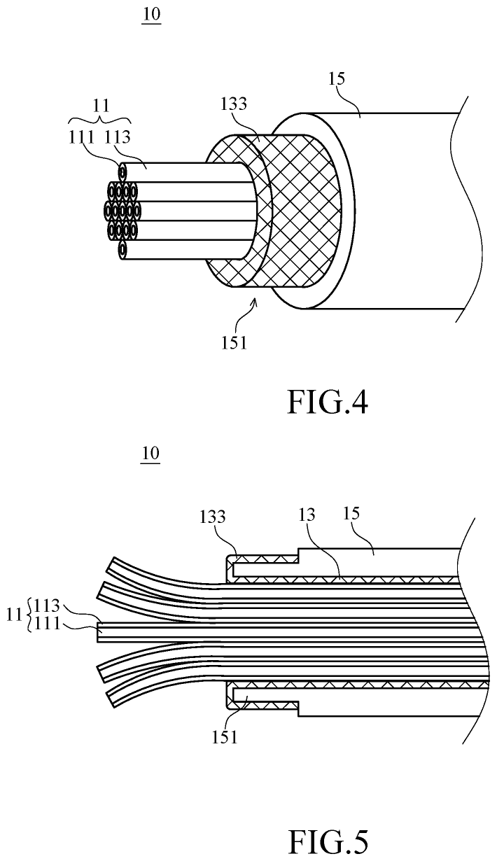

In one embodiment of this disclosure, as shown in FIG. 4 and FIG. 5, a thinned part 151 may be provided on the outer sheath 15 at one or both ends of the transmission line 10, wherein the cross sectional area of the thinned part 151 is smaller than that of the outer sheath 15. In other embodiments of this disclosure, the appearance of the transmission line 10 may be similar to a columnar body, and the thickness of the outer sheath 15 can be uniformly thinned along the radial direction of the columnar body by grinding or cutting, so that the outer diameter of the thinned part 151 will be smaller than that of the outer sheath 15. For example, the cross sections of the outer sheath 15 and the thinned part 151 are both annular.

The exposed conductive layer 131 may be folded to the thinned part 151 to form a folded part 133 on the thinned part 151. In one embodiment of this disclosure, the thinned part 151 of the outer sheath 15 may be a groove. For example, the groove may be arranged along the radial direction of the outer sheath 15 and concave in the direction of the conductive layer 13, and the exposed conductive layer 131 can be folded into the groove.

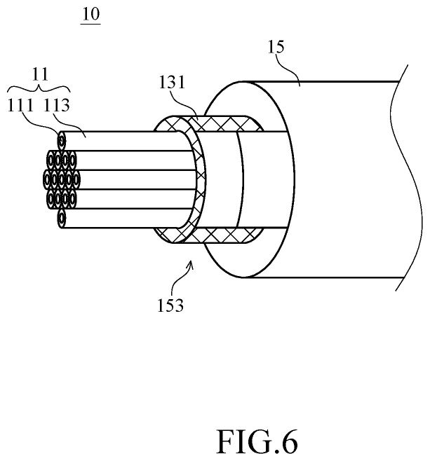

In another embodiment of this disclosure, as shown in FIG. 6, the thinned part 151 of the outer sheath 15 may be a cutting part 153. For example, two symmetrical cutting parts 153 are formed on the outer sheath 15. The cutting part 153 may include a cutting surface, wherein the cutting surface may be a secant of the circular cross section of the outer sheath 15.

The cutting surface of the cutting part 153 may connect to the conductive layer 13, and the conductive layer 13 located on the cutting part 153 is exposed to form an exposed conductive layer 131. In this embodiment, the exposed conductive layer 131 of two transmission lines 10 may be connected to each other via the connection mechanism 100 without folding the exposed conductive layer 131 to the outer sheath 15.

As shown in FIG. 1, a circuit board 21 may be arranged between two transmission lines 10, wherein a plurality of connection terminals 211 are arranged on the circuit board 21. For example, both ends of the circuit board 21 are respectively provided with connection terminals 211, and the conducting wires 11 of the two transmission lines 10 are respectively connected to the connection terminals 211 located at both ends of the circuit board 21.

At least one chip 23 is disposed on the circuit board 21 and is electrically connected to the two connection terminals 211 of the circuit board 21, and the conducting wires 11 of the two transmission lines 10 are connected to the chip 23 via the connection terminals 211 of the circuit board 21. For example, the chip 23 may be a retimer, a redriver, an electronic marker chip (Emarker) or a power amplifier, and the chip 23 is configured to compensate or reduce the attenuation of the signal transmitted by the connection mechanism 100 of the transmission lines 10.

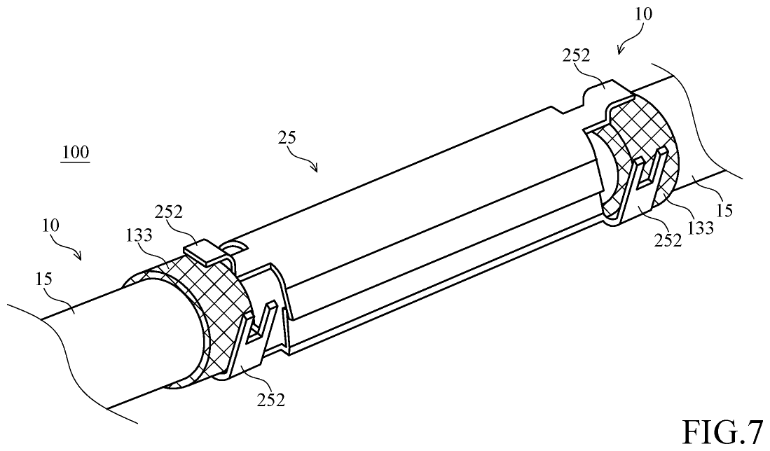

As shown in FIG. 1 and FIG. 7, the metal shell 25 is configured to cover the circuit board 21, the chip 23 and/or part of the transmission lines 10, wherein the metal shell 25 includes an accommodation space 250, and the circuit board 21 and the chip 23 are located in the accommodation space 250 of the metal shell 25 to protect the circuit board 21 and the chip 23.

In addition, the metal shell 25 is connected to the exposed conductive layers 131 or the folded part 133 of the two transmission lines 10, and the conductive layers 13 of the two transmission lines 10 are connected to each other through the metal shell 25, so that the metal shell 25 forms a shielding structure around the circuit board 21 and the chip 23.

In one embodiment of this disclosure, the metal shell 25 may include a first metal shell 251 and a second metal shell 253. The first metal shell 251 is configured to connect to the second metal shell 253 to form the accommodation space 250 therebetween. In practical application, the circuit board 21 and the chip 23 are covered by the first metal shell 251 and the second metal shell 253, and then the first metal shell 251 and the second metal shell 253 can be fixed on one end of the two transmission lines 10 through the fixing unit. For example, the fixing unit may be a screw or a laser solder.

In addition, both ends of the first metal shell 251 and the second metal shell 253 may be respectively provided with a clamping part 252 for connecting and clamping the exposed conductive layers 131 or the folded parts 133 of the two transmission lines 10 respectively, and the first metal shell 251 and the second metal shell 253 are configured to fasten on or connect to the two transmission lines 10 via the clamping part 252. For example, the clamping part 252 of the first metal shell 251 is a single-piece protruding structure, and is configured to press against the exposed conductive layer 131 or the folded part 133 of the transmission line 10 from above. The clamping part 252 of the second metal shell 253 may be a bifurcated structure, and is configured to support or clamp the exposed conductive layer 131 or the folded part 133 of the transmission line 10 from below.

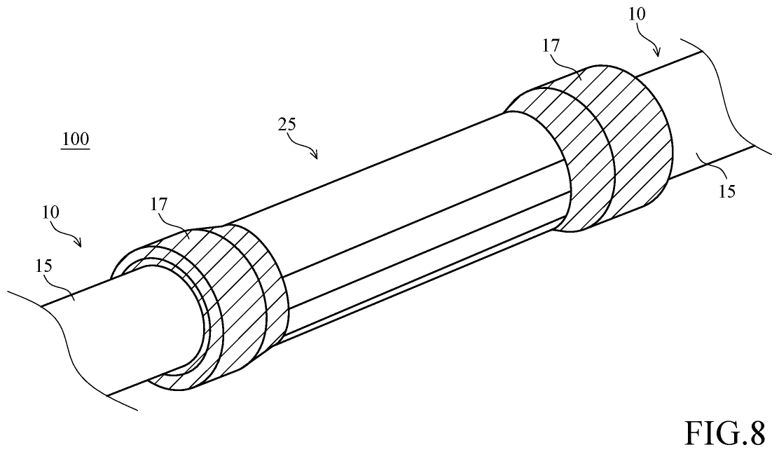

As shown in FIG. 8, both ends of the metal shell 25 may be respectively covered by a metal conductive layer 17. For example, the metal conductive layer 17 may be copper foil or aluminum foil, and is wound around the clamping parts 252 at both ends of the first metal shell 251 and the first metal shell 251. In one embodiment of this disclosure, the metal conductive layer 17 may further cover part of the outer sheath 15 of the transmission line 10.

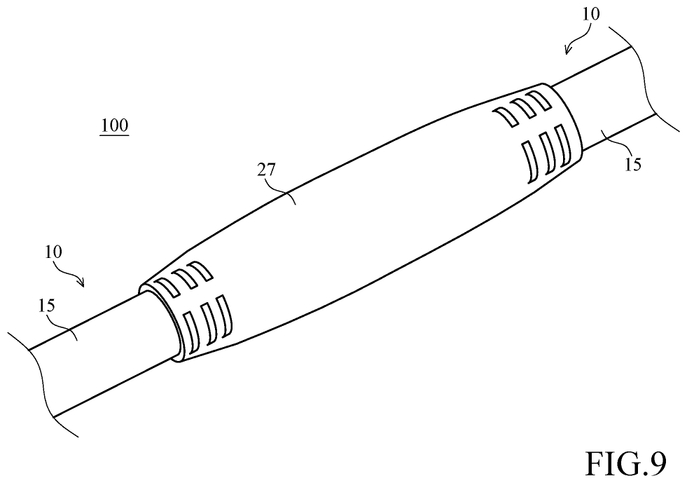

As shown in FIG. 9, an insulation shell 27 is configured to cover the metal shell 25, the metal conductive layer 17 and part of the outer sheath 15 of transmission lines 10, so that the metal shell 25 and/or the conductive layer 13 of transmission lines 10 is isolated from the outside.

Through the connection mechanism 100 of the transmission lines of this disclosure, the length of the transmission line 10 can be extended, while the attenuation of the transmission signal transmitted by the connection mechanism 100 can be compensated or reduced.

In another embodiment of this disclosure, the two transmission lines 10 of FIG. 4, FIG. 5 and FIG. 6 can be electrically connected to each other through the circuit board 21 and the chip 23 of FIG. 1, and then the metal shell 25 is disposed on the transmission line 10 of FIG. 4, FIG. 5 and FIG. 6. The metal shell 25 is configured to cover the circuit board 21 and the chip 23, and is connected to the folded part 133 on the thinned part 151 in FIG. 4 and FIG. 5, or is connected to the exposed conductive layer 131 on the cutting part 153 in FIG. 6.

By forming a thinned part 151 or a cutting part 153 on the outer sheath 15 at one end of the transmission line 10, a smaller metal shell 25 can be used to connect the two transmission lines 10, and the size of the insulating shell 27 can be reduced. For example, the cross sectional area or wire diameter of the insulation shell 27 covering the metal shell 25 may be similar to that of the two transmission lines 10.

The conducting wires 11 in the transmission line 10 of this disclosure may include signal wires, wires, coaxial cables, CC wires, SBU1 wires, SBU2 wires and/or Vconn wires, drain wires or power wires, etc. In practical application, the structure of the conducting wire 11 can be changed, so that the conducting wire 11 has functions such as signal transmission, energy transmission or grounding.

The above description is only a preferred embodiment of this disclosure, and is not intended to limit the scope of this disclosure. Modifications should be included within the scope of the patent application of this disclosure.

What is claimed is:

1. A connection mechanism of transmission lines, comprising:
two transmission lines, including:
a plurality of conducting wires, wherein each conducting wire includes an inner conducting core and an insulation layer, and the insulation layer covers the inner conductor core;
a conductive layer covering the plurality of conducting wires;
an outer sheath covering an outer peripheral surface of the conductive layer, wherein the conductive layers at one end of the two transmission lines are exposed to form an exposed conductive layer;
a circuit board located between the two transmission lines and electrically connecting to the conducting wires of the two signal transmission lines;
at least one chip disposed on the circuit board;
a metal shell covering the circuit board and the chip, wherein the metal shell is connected to the exposed conductive layer of the two signal transmission lines, and the circuit board and the chip are located in an accommodating space formed by the metal shell; and
an insulation shell covering the metal shell and part of the two signal transmission lines.

2. The connection mechanism of transmission lines according to claim 1, wherein the exposed conductive layer of the two transmission lines is folded to the outer sheath of the two transmission lines to form a folded part at one end of the two transmission lines, and the metal shell connects to the folded part of the two transmission lines.

3. The connection mechanism of transmission lines according to claim 1, wherein the outer sheath at one end of the two transmission lines includes a thinned part, a cross sectional area of the folded part is smaller than that of the outer sheath, the exposed conductive layer is folded to the thinned part to form a folded part on the thinned part, and the metal shell connects to the folded part of the two transmission lines.

4. The connection mechanism of transmission lines according to claim 3, wherein the thinned part of the outer sheath includes at least groove, and the exposed conductive layer is folded into the groove.

5. The connection mechanism of the transmission lines according to claim 1, wherein the chip includes a retimer, a redriver, an electronic marker chip or a power amplifier.

6. The connection mechanism of the transmission lines according to claim 1, wherein the metal shell includes a first metal shell and a second metal shell, the first metal shell and the second metal shell are configured to cover the circuit board and the chip, and clamp the exposed conductive layer of the two transmission lines.

7. The connection mechanism of the transmission lines according to claim 6, wherein two ends of the first metal shell and the second metal shell both include a clamping part for clamping the exposed conductive layer of the two transmission lines.

8. The connection mechanism of transmission lines according to claim 1, further comprising a metal conductive layer covering two ends of metal shell, and the insulation shell covering the metal shell and the metal conductive layer.

9. The connection mechanism of transmission lines according to claim 1, wherein the conducting wires include a signal wire, a drain wire or a power wire.

10. The connection mechanism of the transmission lines according to claim 1, wherein the thinned part of the outer sheath includes at least one cutting part, and the conductive layer located on the cutting part is exposed to form the exposed conductive layer.
